(19) United States
(12) Patent Application Publication
(10) Pub. No.: US 2024/0204901 A1
(43) Pub. Date: Jun. 20, 2024

(54) DATA PROCESSING METHOD

(71) Applicant: Siemens Mobility GmbH, München (DE)

(72) Inventor: Maximilian Martin, Buttenheim (DE)

(21) Appl. No.: 18/553,651

(22) PCT Filed: Mar. 1, 2022
(86) PCT No.: PCT/EP2022/055069

§ 371 Date: Oct. 2, 2023

(30) Foreign Application Priority Data
Mar. 30, 2021 (DE) 10 2021 203 221.4

(51) Int. Cl. H04J 3/06; H04L 7/04

(52) U.S. Cl. CPC H04J 3/0667; H04L 7/048

(57) ABSTRACT

A data processing method and a system for performing the data processing method, in which data are transferred between various network subscribers of a network in a communication cycle and multiple data processing devices are provided as network subscribers. A respective process cycle is run through by each of the multiple data processing devices. The communication cycle is synchronized here with the process cycle of at least one of the multiple data processing devices such that, during a temporal run-through of the communication cycle, a predetermined process step of the process cycle of at least one of the multiple data processing devices is carried out during a time interval, assigned to this predetermined process step, of the communication cycle.

The invention relates to a data processing method, to a system for carrying out the data processing method and also to a computer program product.

Automated industrial processes require computer-aided data processing methods that must satisfy high safety requirements. Even a single error in such a data processing method can cause the industrial process to be interrupted or can even cause damage or injuries to persons. In computer-aided data processing methods errors can arise both through hardware, through software and also through a data transmission. Various methods are already known for recognition and avoidance of such errors. For recognition and avoidance of hardware-related errors for example a processing of data on redundantly available hardware components takes place. For example a data processing program is executed several times on one or on a number of cores of a processor of a hardware component. This has the disadvantage that processing capacities of the processor are occupied solely for a redundant execution of the data processing program. Moreover, because of methods for recognition and avoidance of errors, the data processing method takes longer the better and more reliably an error is to be recognized and avoided. Such a lengthening of the data processing method runs contrary however to a fastest possible execution of the data processing method. In particular high demands for data processing that is as fast as possible are made on control methods that have recourse to a data processing method in order to achieve a high operational reliability.

The object of the invention consists in specifying an alternative data processing method with which, with efficient timing, a high level of operational security can be realized.

This object is achieved by a data processing method with the features of claim 1.

Furthermore the underlying object of the invention lies in specifying a system for carrying out the inventive data processing method.

This object is achieved by a system with the features of the subordinate system claim.

Moreover the underlying object of the invention lies in providing a computer program product for carrying out the inventive data processing method with the inventive system.

This object is achieved by a computer program product with the features of the subordinate computer program product claim.

Advantageous developments of the present invention can be taken from the dependent claims.

In the inventive data processing method data is transmitted between the various network subscribers of a network in accordance with a communication cycle consisting of consecutive intervals defined in a communication scheme. In particular the data is transmitted in a time-controlled manner. Preferably time settings of the network subscribers are synchronized with one another in accordance with a common clock signal for this purpose. This can be realized for example by means of a so-called Precision Time Protocol (PTP) known to the person skilled in the art. During at least one time interval of the communication cycle predefined network subscribers are each either authorized to send or to receive data. The communication cycle can be realized for example on the basis of a time division multiplexing method. The time division multiplexing method is also known as Time Division Multiple Access or also by the abbreviation TDMA derived therefrom. Preferably the Time Division Multiple Access method involves a synchronous Time Division Multiple Access method. In the synchronous Time Division Multiple Access method time intervals are provided with a fixed length. During the said time intervals predefined network subscribers are authorized to send data and further predefined network subscribers to receive data in each case. In this way a communication can be easily physically shared in a network.

Furthermore this enables a convergence with further networks to be achieved with little effort.

It is further conceivable for the data to be transmitted in accordance with a secure data transmission protocol. This can for example involve a transmission protocol in accordance with the IEC 61784-3 Standard. In this way an integrity of the transmitted data can be ensured. Moreover security demands that are made on the transmission of data in a network can be complied with in a simple way.

In a further advantageous embodiment variant the data is transmitted between various network subscribers in accordance with a publish/subscribe protocol. For this the data can be transmitted for example in accordance with the OPC UA PubSub standard. In this way an addressing of the data by a sender can be dispensed with. The data can thus be transmitted with little effort by one or more senders to one or more recipients not known to the senders.

Preferably, during a time interval of the communication cycle at least two predefined network subscribers are authorized to transmit data. Especially preferably in this one time interval at least one of the at least two predefined network subscribers is authorized to send and at least a further one of the at least two network subscribers is authorized to receive. In this way a reliable flow of data from a sender to a recipient can be made possible.

Furthermore, in the inventive data processing method, a number of data processing apparatuses are provided as network subscribers. A data processing apparatus can for example be one or more microprocessors, a computer or another apparatus known to the person skilled in the art for execution of machine-readable instructions. A process cycle is executed here by each of the number of data processing apparatuses in each case. In the respective process cycle consecutive process steps are carried out, in which in each case at least a part of the data is either read in, processed or output. In particular the process cycle here is a basic scheme according to the input-processing-output principle. There can be any given arrangement and also sequence of the individual process steps here.

Moreover in the inventive data processing method the communication cycle is synchronized with the process cycle of at least one of the number data processing apparatuses in such a way that, during a time that the communication cycle is executing, a predefined process step of the process cycle of the at least one of the number of data processing apparatuses is carried out during a time interval assigned to this predefined process step of the communication cycle. In this way it is made possible for a duration of the data processing method to be kept short. The duration of the data processing method can largely be kept independent of a number of network subscribers participating in the data processing method, in particular independent of a number of data processing apparatuses. Furthermore, in the inventive data processing method, the communication cycle and also the process cycle of the said at least one of the number of data processing apparatuses can execute multiple times.

By means of the inventive data processing method a flow of data between sender and recipient can be assigned in a reliable way. It can further be achieved that data from a number of network subscribers can be simultaneously received, processed and/or output. A number of data processing apparatuses can execute process cycles in parallel to one another and, in doing so, carry out process steps at the same time. Depending on the process steps, a flow of data between predefined senders and predefined recipients can be uniquely assigned. A disadvantageous lengthening of the data processing method with an increasing number of network subscribers, in particular data processing apparatuses, can be easily prevented in this way.

Preferably the said communication cycle, as well as all process cycles of the number of data processing apparatuses synchronized with the said communication cycle, can be executed multiple times. This makes possible the use of the data processing method in cyclically repeating processes, such as for example control methods.

In an advantageous development of the data processing method there is provision for the predefined process step of the process cycle to be carried out completely within the time interval assigned to this predefined process step of the communication cycle. Each process step can in this way be uniquely assigned to a time interval. This makes it possible to conclude a process step before a change of authorizations of the network subscriber occurs in a following time interval. In this way errors during the transmission of data, such as for example a loss of data to be transmitted, can be prevented.

In an advantageous embodiment variant of the development there is provision for a duration of the predefined time interval to be adapted to a duration of the predefined process step so that the duration of the predefined time interval is essentially equal in length to the duration of the predefined process step. Time sections of the communication cycle during which no data transmission is taking place can be prevented in this way.

In a further advantageous development there is provision, during a first type of time interval of the communication cycle, for at least one of the number of data processing apparatuses to be authorized for receiving data. During this first type of time interval input data is read in by this at least one data processing apparatus. This makes it possible in a simple way to predetermine a flow of data from a group of network subscribers through to at least one data processing apparatus. Input data can for example be data detected by sensors. Input data can in particular be actual status data of a method to be controlled.

In an advantageous embodiment variant of the aforementioned further development there is provision, during the first type of time interval of the communication cycle, for the number of data processing apparatuses to be authorized for receiving data. Furthermore, during this first type of time interval, there is provision for identical input data to be read in from each of the number of data processing apparatuses in each case. In this way a duration for reading in input data is independent of an overall number of data processing apparatuses to the greatest possible extent.

Furthermore, in an advantageous development, there is provision, during a second type of time interval of the communication cycle, for input data to be processed to an output dataset by means of at least one of the number of data processing apparatuses. In this way, during the second type of time interval, there can be a transfer of data between any given group of network subscribers. In this way free transmission capacities can be utilized. In particular any given network subscriber can be authorized to send and further network subscribers to receive within the second type of time interval.

In an advantageous embodiment variant of the aforementioned development there is provision, during the second type of time interval, for a checksum to be computed from the output dataset by means of the at least one of the number of data processing apparatuses. With the aid of a checksum a content of the output dataset can be provided in summarized form. In particular output datasets with the same content have the same checksum.

In a further advantageous embodiment variant of the aforementioned development there is provision for the input data to be processed to an output dataset during a second type of time interval by each of the number of data processing apparatuses by means of the same deterministic data processing program. A deterministic data processing program, in the present context, is to be understood as a program that, when executed repeatedly, starting from the same input data, computes the same output dataset each time. Deviations between the output data that, starting from the same input data, was computed by the deterministic data processing program, can only differ in hardware-related errors. In this way any given scalable number of output datasets computed independently of one another can be created in an efficiently timed manner, in particular at the same time. It is conceivable in this case for the said data processing program to be stateless. In the case of a stateless data processing program the output datasets are solely dependent on the input data. Preferably, during the second type of time interval, a checksum is computed from the output dataset by each of the number of data processing apparatuses. The checksum makes a simple and rapid comparison of the output datasets possible.

It is further conceivable for at least a part of the number of data processing apparatuses, for the input data, instead of being processed by the said same data processing program, to be processed to an output dataset by means of a data processing program similar to the said data processing program. Two similar data processing programs are to be understood in the present context as both data processing programs, starting from the same input data, being programmed in a different way to compute the same output dataset. In particular similar data processing programs are programmed diversely. A comparison of the output datasets of the differently programmed data processing programs makes it possible, as well as the aforementioned occasional errors, additionally to recognize systematic errors that are based on programming errors.

Another advantageous development makes provision, during a third type of time interval of the communication cycle, for a transmission of data to be restricted exclusively to a transmission between the number of data processing apparatuses. This enables an output of possibly errored output datasets to be restricted to an output to the number of data processing apparatuses. An influence of a possibly errored output dataset on further network subscribers can be avoided in this way.

In an advantageous embodiment variant there is provision, during the third type of time interval, for just one first data processing apparatus of the number of data processing apparatuses to be authorized for receiving data and for further data processing apparatuses of the number of data processing apparatuses to be authorized for sending data. During the third type of time interval one output dataset is output in each case by the further data processing apparatuses in each case, which is read in by means of the first data processing apparatus. This makes possible a central and efficiently-timed data processing with precisely one data processing apparatus.

In a further advantageous embodiment variant there is provision, during the third type of time interval, for the checksum computed in each case in the second type of time interval to be output by the further data processing apparatuses. Here a checksum is output by a part of the further data processing apparatuses instead of the output dataset. In this way a quantity of data to be transmitted in the network can be reduced and in particular the third type of time interval can be shortened.

In a further advantageous development there is provision, during a fourth type of time interval of the communication cycle, for exclusively the first data processing apparatus to be authorized for sending data. During the fourth type of time interval its own output dataset is compared by means of the first data processing apparatus with at least one output dataset read in. In an advantageous alternate embodiment variant a checksum of the own output dataset is compared with the checksums read in during the fourth type of time interval by means of the data processing apparatus. The comparison enables a simple and low-cost recognition of occasional and/or systematic errors in the output datasets to be realized. A comparison of checksums instead of output datasets enables the fourth type of time interval to be shortened.

An advantageous development further makes provision, in the case of a match between the own output dataset and the at least one output dataset read in during the fourth type of time interval, for the own output dataset to be output by the first data processing apparatus. As an alternative there is provision, in the case of a match between the checksum of the own output dataset and the checksums read in during the fourth type of time interval, for the own output dataset to be output by the first data processing apparatus. Thus there can be a low-cost verification of the own output dataset in a simple way by means of an output dataset read in or by the checksums read in. It is further conceivable for an own time interval to be provided for output of the output dataset by the first data processing apparatus. In an advantageous form of embodiment, during the fourth type of time interval, at least one network subscriber intended for receipt of the output dataset is authorized to receive the output dataset. For example a network subscriber embodied as an actuator is authorized here for receipt of the output dataset. This makes possible a unique assignment of the flow of data between the network subscribers.

An advantageous development further makes provision, in the case of a deviation between the own output dataset and an output dataset read in during the fourth type of time interval, for such an output dataset to be output by the first data processing apparatus as is a match for at least one further output dataset read in. However this requires that in the third type of time interval at least two output datasets are read in by means of the first data processing apparatus. On the other hand, should just one output dataset be read in by means of the first data processing apparatus during the third type of time interval, an output of an output dataset by means of the first data processing apparatus is prevented. As an alternative there is provision, in the case of a deviation between the checksum of the own output dataset and at least one checksum of the checksums read in by the first data processing apparatus during the fourth type of time interval, for such an output dataset to be output of which the checksum matches at least a further checksum. In the case of the comparison of the checksums it can be sufficient, by means of the first data processing apparatus, as well as the checksums, to read in just one output dataset of at least one of the further data processing apparatuses during the third type of time interval. In this way a simple and reliable verification of output datasets is possible. By a verified output dataset being output by a further data processing apparatus an interruption of the data processing method can be prevented.

The inventive data processing method can be carried out by means of the inventive system.

The inventive system has a network that is configured to transmit data between various network subscribers of the network in accordance with a communication cycle consisting of consecutive time intervals defined in a communication scheme. Through this predefined network subscribers of the network are able to be authorized during one or more predefined time intervals for sending or receiving of the data in each case. The communication scheme, the communication cycle and the time intervals in particular involve the communication scheme, the communication cycle and the time intervals that have each already been described above in conjunction with the data processing method. The inventive system furthermore has a number of data processing apparatuses, which are each embodied as a network subscriber. The data processing apparatuses here correspond in particular to the data processing apparatuses described in conjunction with the data processing method. The number of data processing apparatuses are each configured to read in at least a part of the data in a process cycle consisting of consecutive process steps, to process it and/or to output it. The process cycles and also the associated process steps correspond here in particular to those process cycles already previously described in conjunction with the data processing method and also to their associated process steps. Moreover, in the inventive system, the communication cycle is synchronized with the process cycle with at least one of the number of data processing apparatuses in such a way that, during an execution of the communication cycle over time, a predefined process step of the process cycle of the at least one of the number of data processing apparatuses is able to be carried out during a time interval of the communication cycle during one of these predefined process steps. Furthermore there is provision in the inventive system for a multiple execution of the communication cycle and of the process cycle of the said at least one of the number of data processing apparatuses. In this way a system can be provided that offers any given scalability in respect of a number of network subscribers without a duration of the data processing method disadvantageously being prolonged.

In an advantageous development at least one sensor is provided as a network subscriber. This makes a simple provision of input data possible.

A further advantageous development makes provision for at least one actuator to be provided as network subscriber. In this way a system to be controlled can rapidly and reliably be transferred into a required state on the basis of an output dataset.

By means of the inventive computer program product the inventive system can be made to carry out the inventive data processing method. For this purpose the computer program product has machine-readable instructions. This makes possible an effortless implementation of the data processing method.

The characteristics, features and advantages of the invention described above as well as the manner in which they are achieved, are explained in greater detail in conjunction with the figures in the description given below of an exemplary embodiment of the invention. When expedient, the same reference characters are used in the figures for elements of the invention that are the same or that correspond to one another. The exemplary embodiment serves to explain the invention and does not restrict the invention to the combination of features specified therein, not even with regard to functional features. Moreover all specified features can be considered in isolation and combined in a suitable way with features of any given claim.

In the figures:

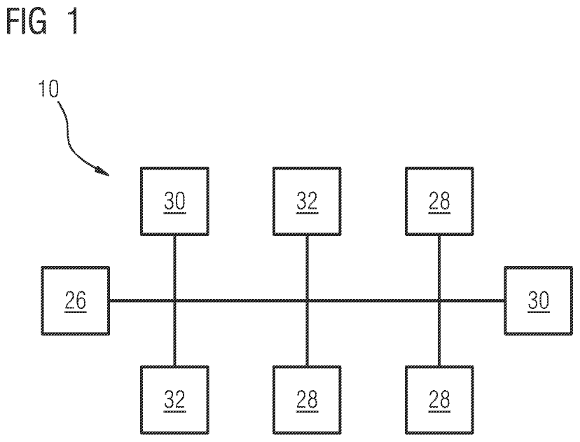

FIG. 1 shows an illustration of an exemplary embodiment of an inventive data processing method and a schematic diagram of an exemplary embodiment of an inventive system for carrying out the data processing method;

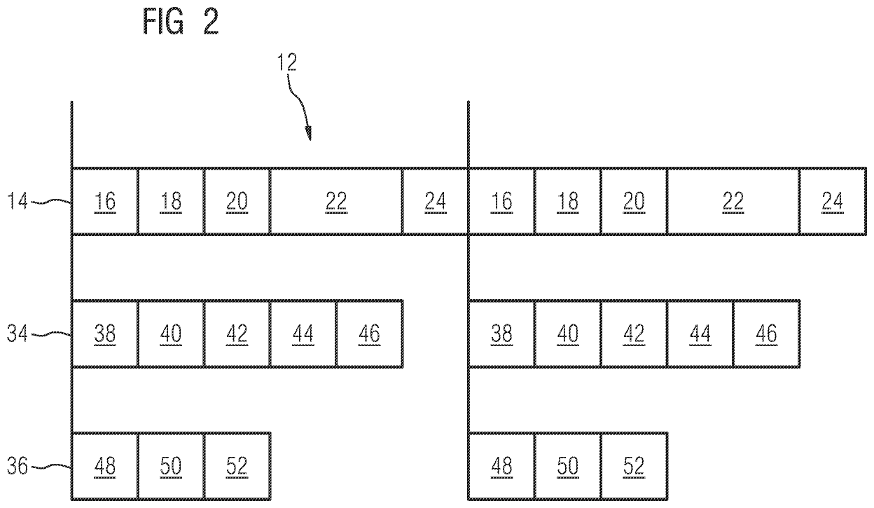

FIG. 2 shows an illustration of the timing of an execution of the exemplary embodiment of the data processing method.

FIG. 1 shows an exemplary embodiment of a network 10. The exemplary embodiment is shown schematically here as a logical topology. A physical topology of the network 10 can differ from the logical topology shown in FIG. 1. Furthermore FIG. 1 illustrates an exemplary embodiment of a data processing method, which processes actual state data of a method to be controlled into required state data of the method to be controlled. The network 10 can basically have any given number of network subscribers. In FIG. 1 and in the description that follows, for reasons of clarity, only those network subscribers are described and shown that are relevant for a description of the following exemplary embodiment.

In the present exemplary embodiment a first data processing apparatus 26, three further data processing apparatuses 28, two sensors 30 and also two actuators 32 are provided as network subscribers of the network 10. The two sensors 30 are each configured to detect actual state data of the method to be controlled. The two actuators 32 are each configured to receive required state data of the method to be controlled. On the basis of this required state data the method to be controlled is transferred from an actual state into a required state in the present exemplary embodiment by means of the two actuators 32. Furthermore, in the present exemplary embodiment the required state data is computed by means of a deterministic data processing program on the basis of the actual state data. The same deterministic data processing program is executed both by the first data processing apparatus 26 and also by the three further data processing apparatuses 28.

In the network 10 data is able to be transmitted between the various network subscribers. In the present exemplary embodiment the data is transmitted in accordance with a communication cycle 14 defined in a communication scheme 12. In the present exemplary embodiment the communication cycle 14 is realized in accordance with a synchronous time division multiplexing method. This can be implemented for example by means of the Standard “IEEE 802.1Qbv”. For this purpose time settings of the network subscribers are synchronized with one another in accordance with a common clock signal. The time settings of the network subscribers can be synchronized with one another for example by means of a so-called “Precision Time Protocol (PTP)”. Furthermore the data is transmitted between the network subscribers on the basis of a “publish/subscribe” protocol. The Standard “OPC UA PubSub” can be used as the publish/subscribe protocol for this purpose for example. Moreover, in the present exemplary embodiment, the data is transmitted in accordance with a secure transmission protocol between the network subscribers.

FIG. 2 illustrates the timing of the execution of the exemplary embodiment of the data processing method. The communication cycle 14 consists in the present exemplary embodiment of five consecutive time intervals 16, 18, 20, 22, 24, which each, in accordance with the synchronous time division multiplexing method, have a fixed length. The lengths of time intervals 16, 18, 20, 22, 24 can be different. In the communication scheme 12 it is defined which network subscriber is authorized for sending or for receiving in which time interval. FIG. 2 furthermore illustrates a first process cycle 34, which is executed by the first data processing apparatus 26. The first process cycle 34 has five consecutive 6 process steps 38, 40, 42, 44, 46. FIG. 2 moreover illustrates a further process cycle 36. The further process cycle 36 is executed by each of the three further data processing apparatuses 28. The further process cycle 36, in the present exemplary embodiment, further has three consecutive process steps 48, 50, 52.

The communication cycle 14 is synchronized with the first process cycle 34 and the further process cycle 36 in such a way that, during an execution time of the communication cycle 14, each process step 38, 40, 42, 44, 46 of the first process cycle 34 and also each process step 48, 50, 52 of the further process cycle 36 is carried out completely during precisely one of the respective time intervals 16, 18, 20, 22 of the communication cycle 14 assigned to the process steps 38, 40, 42, 44, 46, 48, 50, 52. Moreover, in the present exemplary embodiment of the communication cycle 14, the first process cycle 34 and also the further process cycle 36 have the same starting time.

In the present exemplary embodiment, during a first time interval 16 of the communication cycle 14, both the first data processing apparatus 26 and also the three further data processing apparatuses 28 are authorized to receive data. Moreover, in the first time interval 16 the two sensors 30 are authorized to send data. This makes it possible for the first data processing apparatus 26 in a first process step 38 of the first process cycle 34 and also for the three further data processing apparatuses 28 in a first process step 48 of the further process cycle 36, to read in as input data the actual state data of the method to be controlled provided by the two sensors 30. This input data is read in here by means of the first data processing apparatus 26 and the three further data processing apparatuses 28 at the same time. During the first time interval 16 the input data is read in completely by the said data processing apparatuses 26, 28.

Regardless of the present exemplary embodiment, any given number of data processing apparatuses is conceivable here as network subscribers, through which, with any extension of the time of the data processing method the same input data is able to be processed.

During a second time interval 18 a second process step 40 of the first process cycle 34 and also a second process step 50 of the further process cycle 36 are carried out at the same time. Here the input data for one output dataset in each case is completely processed by the first data processing apparatus 26 and the three further data processing apparatuses 28 by means of the same deterministic data processing program in each case. As an alternative or in addition it is conceivable here for at least one of the three further data processing apparatuses 28 and/or at least one additional data processing apparatus not shown in any greater detail, to execute another data processing program instead of the same data processing program completely during the second time interval 18. The other data processing program here would only be distinguished from the aforementioned data processing programs in that it is programmed in another way, on the basis of the same input data, to compute the same output dataset as the aforementioned data processing programs. A deviation between the output datasets that have been computed by one data processing program of the same data processing programs and the output dataset that has been computed by the other data processing program, can therefore be based both on programming errors and also on random, hardware-related faults. The output dataset in the present exemplary embodiment has the required state data. Moreover, during the second time interval 18, checksums are formed from the respective output datasets. Accordingly, the same checksums are produced for output datasets with the same contents. If the checksums deviate from one another then a content of the output datasets also deviates from one another. During the second time interval 18 any given network subscribers can be authorized to send and any given further network subscribers to receive data. In particular this can involve network subscribers of the network 10 not shown or described in any greater detail in conjunction with this exemplary embodiment.

The second time interval 18 of the communication cycle 14 is followed by a third time interval 20 of the communication cycle 14. During the third time interval 20 a transmission of data is exclusively restricted to a transmission between the first data processing apparatus 26 and the three further data processing apparatuses 28. Here the first data processing apparatus 26 is authorized to receive data and the three further data processing apparatuses 28 are each authorized to send data. During the third time interval 20, by means of the three further data processing apparatuses 28, a third process step 52 of the further process cycle 36 is carried out completely in each case. Here, in the present exemplary embodiment, both the computed output dataset and also a checksum of the same are output by one of the three further data processing apparatuses 28. In this third process step 52 just one checksum of each of the respective, calculated output datasets is output by the remaining two of the three further data processing apparatuses 28. Moreover a third process step 42 of the first process cycle 34 is carried out during the third time interval 20 by means of the first data processing apparatus 26. In this third process step 42 of the first process cycle 34, by means of the first data processing apparatus 26, the data output by means of the three further data processing apparatuses 28 is read in. The fact that the transmission of data during the third time interval 20 is exclusively restricted to a transmission between the first data processing apparatus 26 and the three further data processing apparatuses 28 enables it to be excluded that, incorrectly, the output dataset output by means of the said one of the three further data processing apparatuses 28 can accidentally be output to the actuators 32.

During a fourth time interval 22 of the communication cycle 14 exclusively the first data processing apparatus 26 is authorized to send data. The two actuators 32 are authorized to receive data in the fourth time interval 22. During the fourth time interval 22 both a fourth process step 44 of the first process cycle 34 and also a fifth process step 46 of the first process cycle 34 are carried out completely. As an alternative it would be conceivable here for an own time interval to be assigned to the fourth process step 44 and the fifth process step 46 in each case, in which the respective process steps are able to be carried out completely. In the fourth process step 44 a checksum of the own output dataset is compared by the first data processing apparatus 26 with the checksums read in in the preceding third process step 42 of the first process cycle 34.

In the case of a match between the checksum of the own output dataset with the respective checksums read in, in the fifth process step 46 of the first process cycle 34 during the fourth time interval 22, the own output dataset is output by the first data processing apparatus 26.

In the case of a deviation between the checksum of the own output dataset and at least one of the checksums read in, a verified output dataset is output by the first data processing apparatus 26. To this end the first data processing apparatus 26 determines which of the checksums deviates from the other checksums. Provided the own checksum differs as the only one from the checksums read in, in the fifth process step 46 the output dataset read in in the third process step 42 is output. Should one of the checksums read in differ from the own and the two further checksums read in however, then in the fifth process step 46 the own output dataset is output in its turn. This procedure makes possible a simple verification of the output datasets. As an alternative, in the case of a deviation between the checksums, either an output of an output dataset can be dispensed with, or the data processing method can be aborted. For example the method to be controlled can be put into a secure state, in which the method to be controlled is interrupted.

Lastly the communication cycle 14 in the present exemplary embodiment has a fifth time interval 24. This fifth time interval 24 is not assigned any process step of the said process cycles 34, 36. During the fifth time interval 24 any given network subscribers can be authorized to send and any further network subscribers to receive data.

FIG. 2 further illustrates that the communication cycle 14, the first process cycle 34 and also of the further process cycle 36 are executed multiple times. Here the communication cycle 14, the first process cycle 34 and also the further process cycle 36 are executed synchronized each time. This is achieved in the present exemplary embodiment by the starting times of the communication cycle 14, of the first process cycle 34 and of the further process cycle 36 matching each other at the beginning of a new execution in each case.

Although the invention has been illustrated and described in greater detail by the preferred exemplary embodiments, the invention is not restricted by the disclosed examples and other variations can be derived herefrom by the person skilled in the art, without departing from the scope of protection of the invention.

1-14. (canceled)

15. A data processing method, which comprises the steps of:
transmitting data between various network subscribers of a network in accordance with a communication cycle containing consecutive time intervals defined in a communication scheme, a plurality of data processing apparatuses being provided as the various network subscribers;
during at least one time interval of the communication cycle, predefined network subscribers of the network subscribers are authorized either to send or to receive data in each case;
executing a process cycle by each of the plurality of data processing apparatuses;
carrying out consecutive process steps in a respective said process cycle, in which at least a part of the data is either read in, processed or output in each case;
synchronizing the communication cycle with the process cycle of at least one of the plurality of data processing apparatuses such that, during an execution time of the communication cycle, a predefined process step of the process cycle of the at least one of the plurality of data processing apparatuses is carried out during a time interval of the communication cycle assigned to the predefined process step; and
executing the communication cycle and also the process cycle of the at least one of the plurality of data processing apparatuses a number of times.

16. The data processing method according to claim 15, which further comprises carrying out the predefined process step of the process cycle completely within the time interval of the communication cycle assigned to the predefined process step.

17. The data processing method according to claim 15, wherein:
during a first type of time interval of the communication cycle at least one of the plurality of data processing apparatuses is authorized to receive data; and
during the first type of time interval input data is read in by the at least one data processing apparatus.

18. The data processing method according to claim 17, wherein:
during the first type of time interval of the communication cycle the plurality of data processing apparatuses is authorized to receive data; and
during the first type of time interval identical input data is read in by the plurality of data processing apparatuses in each case.

19. The data processing method according to claim 15, wherein during a second type of time interval of the communication cycle, by means of at least one of the plurality of data processing apparatuses input data is processed to an output dataset.

20. The data processing method according to claim 19, wherein during the second type of time interval, processing the input data to the output dataset by each of the plurality of data processing apparatuses by means of a same deterministic data processing program.

21. The data processing method according to claim 20, wherein during a third type of time interval of the communication cycle, a transmission of data is exclusively restricted to a transmission between the plurality of data processing apparatuses.

22. The data processing method according to claim 21, wherein:
during the third type of time interval just a first data processing apparatus of the plurality of processing apparatuses is authorized to receive data and further data processing apparatuses of the plurality of data processing apparatuses are authorized to send data; and
during the third type of time interval one output dataset is output in each case by the further data processing apparatuses, which is read in by means of the first data processing apparatus.

23. The data processing method according to claim 20, wherein:
during the second type of time interval a checksum from the output dataset is computed by means of the further data processing apparatuses; and
during the third type of time interval the checksum is output in each case by means of the further data processing apparatuses, wherein the checksum is output by a part of the further data processing apparatuses instead of the output dataset.

24. The data processing method according to claim 23, wherein:
during a fourth type of time interval of the communication cycle, exclusively a first data processing apparatus of the plurality of processing apparatuses is authorized to send data; and
during the fourth type of time interval by means of the first data processing apparatus, its own output dataset is compared with at least one output dataset read in or a checksum of the own output dataset is compared with the checksum read in.

25. The data processing method according to claim 24, wherein in a case of a match between the own output dataset and the at least one output dataset read in or in a case of a match between the checksum of the own output dataset with the checksum read in during the fourth type of time interval, the own output dataset is output by the first data processing apparatus.

26. The data processing method according to claim 24, wherein in a case of a deviation between the own output dataset and the at least one output dataset read in or in a case of a deviation between the checksum of the own output dataset and the checksum read in, such an output dataset that matches at least one further output dataset read in or of which the checksum matches at least a further checksum is output by the first data processing apparatus.

27. A system for carrying out a data processing method, the system comprising:
a network configured to transmit data between various network subscribers of the network in accordance with a communication cycle containing consecutive time intervals defined in a communication scheme;
a plurality of data processing apparatuses, which are each embodied as a network subscriber and which are each configured to read in, to process and/or to output at least a part of the data in a process cycle containing consecutive process steps;
predefined network subscribers of said network subscribers are each able to be authorized to send or to receive data during at least one of predefined time intervals of the consecutive time intervals;
the communication cycle is synchronized with the process cycle of at least one of said plurality of data processing apparatuses such that, during a time in which the communication cycle is executing, a predefined process step of the process cycle of the at least one of said plurality of data processing apparatuses is able to be carried out during a time interval of the communication cycle assigned to one of the predefined process steps; and
the communication cycle and the process cycle of at least one of said plurality of data processing apparatuses is executed multiple times.

28. A non-transitory computer program product containing machine-readable instructions, when executed on a system carry out the data processing method according to claim 15.
